(19) United States
(12) Patent Application Publication
(10) Pub. No.: US 2020/0364163 A1
(43) Pub. Date: Nov. 19, 2020

(54) DYNAMIC PERFORMANCE ENHANCEMENT FOR BLOCK I/O DEVICES

(71) Applicant: Goke US Research Laboratory, Santa Clara, CA (US)

(72) Inventors: Steven Schauer, Loveland, CO (US); Engling Yeo, San Jose, CA (US)

(21) Appl. No.: 16/412,257

(22) Filed: May 14, 2019

(51) Int. Cl. G06F 13/16; G06F 13/28; G06F 13/42

(52) U.S. Cl. CPC G06F 13/1668; G06F 13/1605; G06F 2213/0026; G06F 13/4282; G06F 13/28

(57) ABSTRACT

Methods and apparatus are described to dynamically adjust internal resources and arbitration schemes of a block I/O device that allows for efficient bandwidth utilization and increased IO performance of the block I/O device. Commands from a plurality of hosts are monitored and measured under various workloads, and the block I/O device dynamically adjusts internal resources and arbitration schemes based on the received commands.

### BACKGROUND

### I. Field of Use

The present invention relates to the field of digital data processing and more specifically to high speed I/O data management.

### II. Description of the Related Art

Flash memory—also known as flash storage—is a type of non-volatile memory that is gaining widespread use in enterprise storage facilities, offering very high performance levels catering to customer expectations for performance, efficiency and reduced operational costs. Such flash memory is typically realized as high-capacity solid state hard drives (SSDs). Several years ago, the well-known Non-Volatile Memory Express (NVMe), version 1.3 standard was released, allowing direct access to such flash memory drives directly over a PCIe serial bus. The NVMe standard version 1.3 is incorporated by reference herein in its entirety.

The NVMe standard provides low-latency and parallelism between a host and one or more peripheral device, such as one or more SSDs, or between a peripheral device and multiple hosts. This is achieved using an architecture that defines multiple submission and completion queues, where submission queue commands are provided to the submission queues by the host, and completion entries are provided by the peripheral device(s) to the completion queues. The architecture further defines doorbell registers that are used by the host to notify a peripheral device of every new submission queue command and to release completion entries.

As shown in FIG. 1, a Root Complex (host computer) initiates I/O commands by placing submission queue commands into a submission queue. The host then sends an entry into a doorbell register in the controller (i.e., solid state drive (SSD), alerting the controller of each submission queue command placed into the submission queue. In response, the controller fetches the submission queue entry from the submission queue and executes the command (i.e., read, write, erase). Next, the controller writes a completion entry into the completion queue, indicating completion of the command, and then generates an interrupt to alert the host that the completion entry has been written to the completion queue. The root complex processes the completion entry and then clears the completion entry from the completion queue. While FIG. 1 illustrates the interaction between a single host and a single controller, in practice, multiple controllers may provide various services (such as data storage) to a single host computer, or multiple host computers may utilize a single controller.

In situations where a single controller services multiple host computers, arbitration may be used to determine which host computer and related submission queue(s) the controller should process next. An arbitration burst setting may determine a maximum number of commands that the controller may start processing from a particular submission queue before arbitration takes place again. The NVMe protocol defines three arbitration mechanisms including round robin, weighted round robin with urgent priority class, and vendor specific. These arbitration methods are used to determine the submission queue from which the controller will process its next command. For example, FIG. 2 illustrates a weighted round robin having two urgent priority classes. All of the submission queues in the “urgent” class are evaluated first, followed by all of the submission queues in the “high” priority class, and so on. The results from the “low” “medium” and “high” are evaluated in the order of their weight (i.e., “low”, “medium” and “high”), then the result is processed depending on whether other strict priority submissions have been received from either an administrative submission queue or a submission queue labeled as “urgent”.

Inefficiencies of bandwidth and I/O performance can result in situations where multiple submission queues are being processed by a controller. For example, multiple host computers may store and retrieve data to a common controller , and each host's computing needs may change over time. Using traditional arbitration methods, hosts having a temporary high need for bandwidth must wait for their turn to have the controller read their submission queues based on whatever arbitration method the controller uses, while hosts having little need are addressed by the controller, again, in accordance with the chosen arbitration method.

It would be desirable to modify traditional arbitration schemes used by controllers to accommodate the varying needs of connected host computers.

### SUMMARY

The embodiments herein describe methods and apparatus for dynamically altering operation a block I/O device based on commands received from a plurality of connected host devices. In one embodiment, a method is described, performed by a block I/O device, the method comprising receiving, by a data bus interface coupled to a processor, host commands from the plurality of hosts coupled to the data bus interface, storing, by the processor via a memory coupled to the processor, one or more characteristics of each of the host commands, and modifying, by the processor, operation of the block I/O device based on the one or more characteristics of at least some of the host commands.

In another embodiment, a block I/O device is described, comprising a data bus interface for receiving host commands from the plurality of hosts, a memory for storing processor-executable instructions, and a processor, coupled to the data bus interface, the mass storage device and the memory, for executing the processor-executable instructions that causes the block I/O device to receive, by the data bus interface, the host commands from the plurality of hosts, store, by the processor, one or more characteristics of each of the host commands, and modify, by the processor, operation of the block I/O device based on the one or more characteristics of at least some of the host commands.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a prior data storage system comprising a host computer and a data storage device, showing signal flow as a command is issued by the host computer and executed by the data storage device;

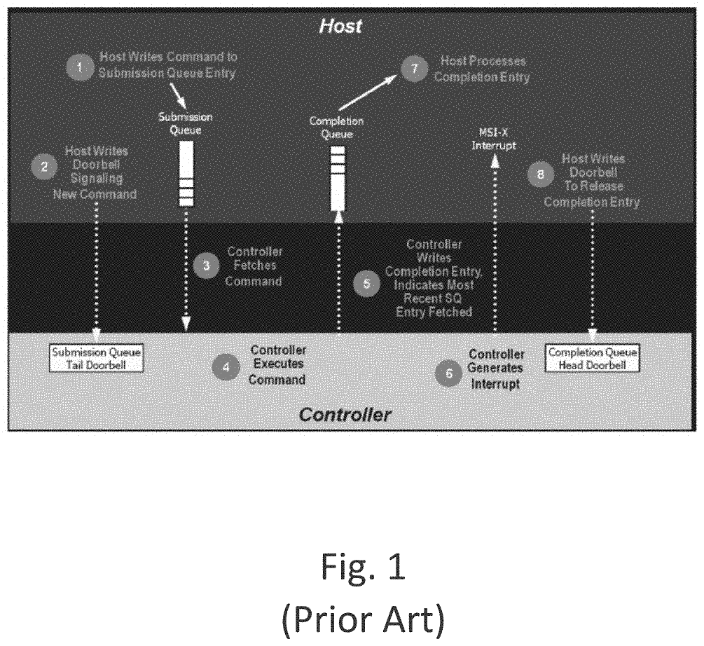

FIG. 2 illustrates a prior art arbitration scheme used in the prior art data storage system as shown in FIG. 1;

FIG. 3 is a functional block diagram of a computer system in accordance with the teachings herein, comprising a plurality of host computers coupled to a controller;

FIG. 4 is a functional block diagram of one embodiment of the controller as shown in FIG.

3;

FIG. 5 is a functional block diagram of another embodiment of the controller as shown in FIG. 3 in accordance with the NVMe specification; and

FIG. 6 is a flow diagram illustrating one embodiment of a method performed by the controller as shown in either FIG. 4 or FIG. 5, for dynamically altering operation of the controller based on commands received from a plurality of connected host computers.

### DETAILED DESCRIPTION

Methods and apparatus are described to dynamically adjust internal resources and/or arbitration schemes of a block I/O device, such as a data storage device, for providing efficient bandwidth utilization and increased 10 performance to a plurality of host computers (or more generally, hosts) coupled to the block I/O device. In one embodiment, the block I/O device comprises an NVMe solid state drive (SSD), and the hosts generate commands that are placed into respective command submission queues, wherein the commands are fetched/processed by an the NVMe SSD in accordance with a dynamic arbitration scheme. Various characteristics of the commands are monitored under various host workloads, and the block I/O device dynamically adjusts the arbitration scheme and/or internal resources based on the characteristics of the commands. This results in the block I/O device consuming less power, generating less heat, and more quickly and efficiently processing commands from the hosts.

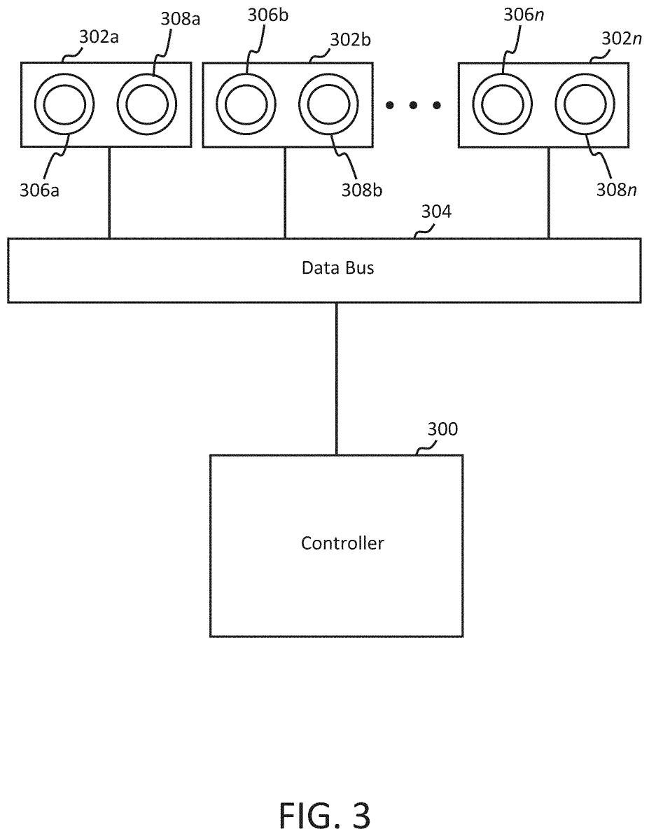

FIG. 3 illustrates a functional block diagram of one embodiment of a system for dynamically adjusting internal resources and/or arbitration schemes of a block I/O device 300, which typically comprises a solid state hard drive. Block I/O device 300 comprises any device that accesses fixed-size chunks, or blocks, of data, such as a Blue-Ray reader. Block I/O 300 is shown coupled to a number of hosts 302a-302n via a high-speed data bus 304. Each of hosts 302a-302n comprise a desktop or laptop computer, mobile phone, wearable device, server, digital camera, or any other electronic device that generates digital data and capable of communicating with block I/O device 300 via data bus 300. In one embodiment, data bus 304 comprises a PCI Express data bus that is capable of high speed data transfers between each host and block I/O device 300. In the embodiment shown in FIG. 3, block I/O device 300 is physically coupled to each of the n hosts via the PCIe data bus, where n can range from 1 to as many as 128 host computers or more. In some embodiments, data bus 304 comprises alternative communication mediums, such as PCIe over fabrics (PCIe-OF), which allows hosts to communicate with block I/O device 300 over wide-area networks, such as the Internet.

The primary function of block I/O device 300 in the embodiment shown in FIG. 3 is high-speed data storage and retrieval for the host computers over data bus 304 using one of any number of high-speed data transfer protocols. In one embodiment, the well-known NVMe protocol is used, which defines both a register-level interface and a command protocol used by block I/O device 300 and the hosts to communicate with each other over data bus 304. For example, block I/O device 300 may comprise a 16-Channel ONFI-compliant NAND SSD with an 800 MBps NVMe interface. Utilizing all 16 channels, data may be stored or retrieved from block I/O device 300 at a throughput of over 12 GBps.

In one embodiment where the NVMe standard is used, each of the hosts 302a-302n comprise at least one command submission queue, shown as submission queues 306a-306n and at least one completion queue, shown as completion queues 308a-308n. In practice, each host typically comprises a plurality of submission queues, up to 64 k submission queues, each submission queue capable of storing 64 k commands. The submission queues are used to temporarily store commands issued by a host processor, where the host processor notifies block I/O device 300 of the presence of a command in the submission queue by sending a doorbell notification to block I/O device 300 that identifies the host and submission queue where the command is located. Block I/O device 300, in turn, retrieves the command from the proper submission queue, in one embodiment, in accordance with an arbitration scheme, using techniques known in the art. In one embodiment, commands are retrieved by block I/O device 300 in the order that the doorbell notifications are received by block I/O device 300, and then the commands are arbitrated as they are temporarily stored in the controller's cache memory.

After each command has been processed, block I/O device 300 provides a completion entry to a completion queue in the proper host that submitted the command to indicate completion of the command.

In one embodiment, block I/O device 300 retrieves/processes commands from the host computers using a dynamic arbitration scheme. The arbitration scheme may be dynamically modified by block I/O device 300 (i.e., at predetermined time intervals or upon the occurrence of one or more predetermined events) in accordance with the commands issued by the hosts, so that hosts having the greatest need for processing are attended to first, or more often, than hosts having fewer processing needs.

In addition or alternative to the dynamic arbitration scheme just described, block I/O device 300 may enable and/or disable a number of block I/O device resources, such as one or more data engines, to help process certain commands from the hosts. Other examples of block I/O device resources include enabling direct memory access (DMA), allocating additional buffer memory, and adjusting internal bus priorities. For example, if a first host has sent 60 read commands in the last second and a second host has sent 60 encrypt commands, block I/O device 300 may enable one or more read engines and one or more encrypt engines to handle the burst of processing required by the first and second hosts. Similarly, block I/O device 300 may disable one or more of such data engines when demand from hosts wanes. Enabling and disabling data engines may be accomplished by removing power to a data engine, a reduction or removal of one or more critical signals to a data engine (such as clock or enable signals), or other techniques known in the art.

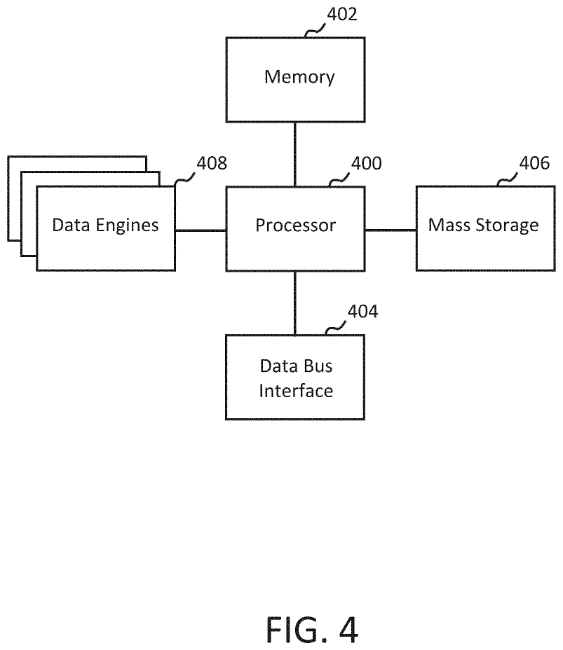

FIG. 4 is a functional block diagram of one embodiment the block I/O device 300 as shown in FIG. 3, comprising processor 400, memory 402, data bus interface 404, mass storage 406 and a plurality of data engines 408.

Processor 400 is configured to provide general operation of block I/O device 300 by executing processor-executable instructions stored in memory 402, for example, executable computer code. Processor 400 typically comprises one or more microprocessor, microcontrollers, custom ASICs, and/or custom RISC-V processors, such as a dual core 32-bit RISC-V CPU that may be customized by a designer of processor 400. The selection and/or design of processor 400 is generally based on computational speed, cost, size, power consumption, heat generation, among other factors.

Memory 402 is coupled to processor 400 and, in some embodiments, other components of block I/O device 300, comprising one or more non-transitory information storage devices, such as RAM, ROM, flash memory, or other type of electronic, optical, or mechanical memory device. Memory 402 is used to store processor-executable instructions for operation of block I/O device 300, as well as a dynamic arbitration scheme and one or more predictive branching algorithms. In some embodiments, a portion of memory 402 may be embedded into processor 400. Memory 402 may additionally comprise one or more separate cache memories for temporary storage of data to or from the host computers. Finally, memory 402 excludes media for propagating signals.

Data bus interface 404 is coupled to processor 400 as well as to other components of block I/O device 300, comprising a high speed, bi-directional interface between the host computers and block I/O device 300. Data bus interface 404 comprises circuitry to implement physical layer functions for transport of data and, typically, an end point controller. In one embodiment, data bus interface 404 is coupled to data bus interface logic (described later herein), which is responsible for managing data bus interface 404 so that block I/O device 300 appears to the computer hosts as a block IO device. In this embodiment, the data bus interface logic performs all command processing and error handling as required by the NVMe interface protocol. In some embodiments, data bus interface 404 translates AXI commands and associated data from processor 400 into PCIe Transfer Layer Packets (TLPs). Conversely, data bus interface 404 receive PCIe packets (TLP/CPLD) from data bus 304 and translates them into AXI commands and data packets which are then passed to the processor 400 and/or the data engine modules, described later herein.

Mass storage memory 406 is coupled to processor 400 as well as other components of block I/O device 300, comprising one or more non-transitory, non-volatile, information storage devices, such as flash memory, or other suitable type of high-speed electronic, optical, or mechanical memory, used to store data provided by the hosts. In one embodiment, mass storage memory 406 comprises a number of NAND flash memory chips, arranged in a series of banks and channels, to provide storage on the order of multiple terabytes. Mass storage memory 406 is typically coupled to one or more flash channel controllers (not shown) as well as one or more cache memories, where data for storage is temporarily stored by processor 400. Mass storage device 406 excludes media for propagating signals.

Data engines 408 are coupled to processor 400 and other components of block I/O device 300 to execute the various commands received from the hosts. Each data engine may perform a certain function, such as reading, writing, encrypting, encoding, compressing, writing, decrypting, decoding, and uncompressing data to/from the hosts, providing direct memory access (DMA), allocating additional buffer memory, adjusting internal bus priorities, etc. Typically, block I/O device 300 comprises multiple ones of each type of data engine, so that block I/O device 300 may dynamically scale each function up or down depending on the needs of the hosts. Each data engine comprises circuitry and in some cases firmware to perform its intended function and each data engine is capable of being enabled and disabled by processor 400, again depending on the needs of the host computers. In one embodiment, the data engines may be formed as part of an ASIC or other programmable processing device as part of processor 400.

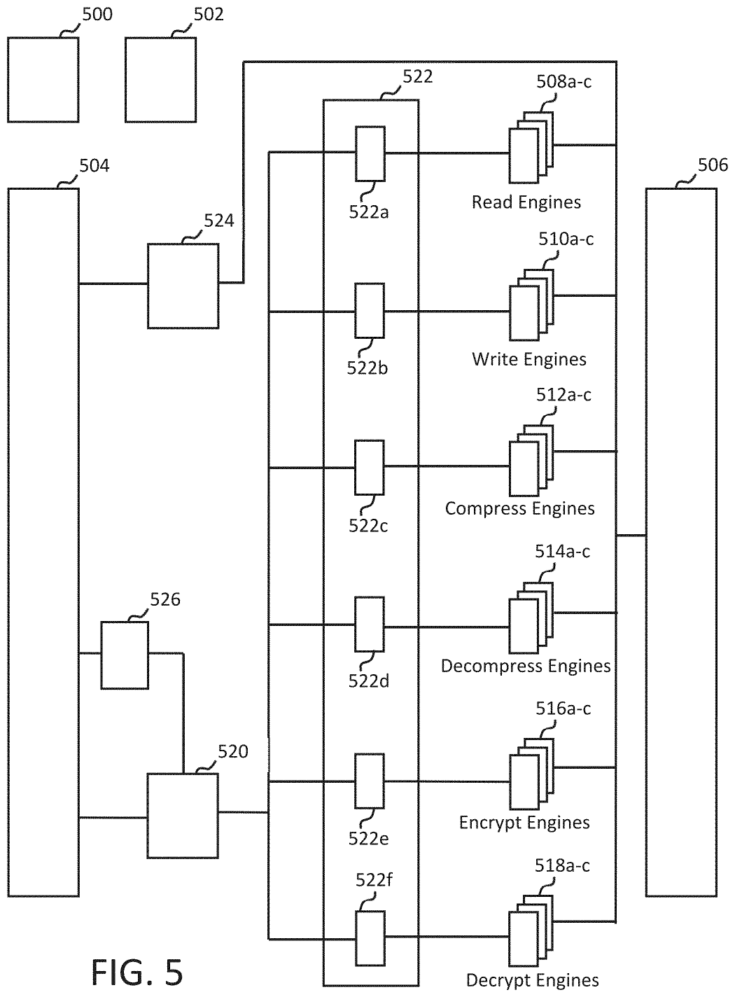

FIG. 5 is a functional block diagram of one embodiment of block I/O device 300 as shown in FIG. 4 that utilizes an NVMe architecture, comprising processor 500, memory 502, data bus interface 504, mass storage 506, read engines 508a-c, write engines 510a-c, compression engines 512a-c, decompression engines 514a-c, encryption engines 516a-c, decryption engines 518a-c, command handler 520, cache memory 522 command completer 524. Processor 500 and memory are shown as unconnected to the other functional blocks, but in practice, each of these blocks may be coupled to any or all of the other functional blocks. Further, while FIG. 5 illustrates the use of six different types of data engines (i.e., read, write, encryption, decryption, compression and decompression), in other embodiments, a different number, or types, of data engines could be used. Also, while FIG. 5 illustrates an equal number of each type of data engine, in other embodiment, the number of data engines could vary among the different types of data engines. FIG. 5 may exclude one or more minor functional blocks, such as a number of cache memories, a flash controller, etc., as these components are well known and a detailed explanation of each of these blocks is unnecessary for an understanding the inventive concepts described herein.

Processor 500, memory 502, data bus interface 504, mass storage 506 and data engines 508-516 perform functions similar to those described in reference to processor 400 and memory 402 in FIG. 4. However, in this embodiment, command handler 520, cache memory 522, command completer 524 and doorbell register 526 are shown to provide more detail in an embodiment utilizing NVMe.

Command handler 520 is coupled to processor 500, comprising circuitry and firmware for executing the arbitration scheme, fetching and/or executing commands from the hosts in accordance with the arbitration scheme, validating commands, recording/tracking characteristics of each received command, and routing the commands to one of the cache memory FIFO buffers 522a-522f within cache memory 522. Command completer 524 is coupled to processor 500, the data engines and data bus interface 404, comprising circuitry and firmware for generating completion queue entries (CQEs) to the hosts after completion of each submission queue command. Command completer 524 may also automatically generate interrupts, such as MSI/MSI-X message signal interrupts, to the hosts, indicating that a command has been executed. More details of each of these components will be explained later herein.

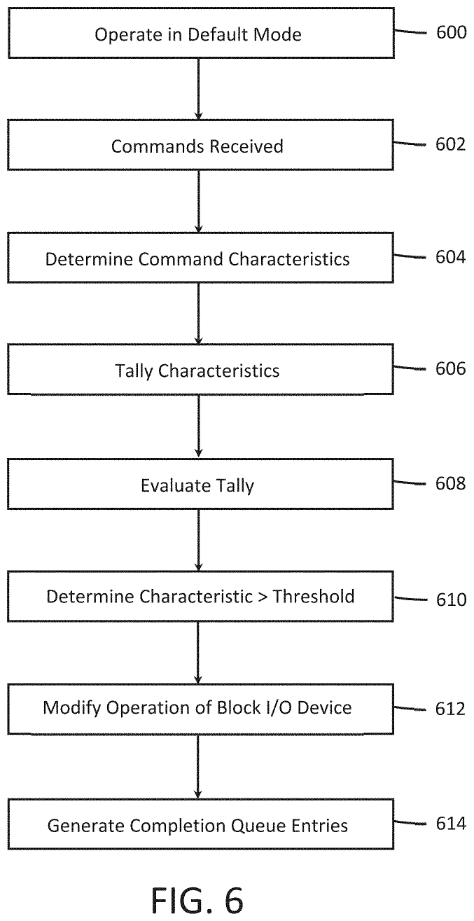

FIG. 6 is a flow diagram illustrating one embodiment of a method performed by block I/O device 300 to dynamically adjust internal resources and/or arbitration schemes of block I/O device 300 to maximize bandwidth utilization and increase IO performance for a plurality of connected hosts. The method is described with respect to the system as shown in FIG. 3, and with respect to block I/O device 300 as shown in both FIG. 4 and FIG. 5. Thus, reference to processor 400 may additionally apply to processor 500 and/or command handler 520. The term “processor” may also apply to command handler 520. Also in this embodiment, block I/O device 300 comprises three read engines, three write engines, three encryption engines, three decryption engines, three encoder engines and three decoder engines. It should be understood that in some embodiments, not all of the steps shown in FIG. 6 are performed and that the order in which the steps are carried out may be different in other embodiments. It should be further understood that some minor method steps have been omitted for purposes of clarity. Finally, it should be understood that although the method steps below discuss the inventive concepts herein as applied to a solid state drive, in other embodiments, the same concepts can be applied to other applications without departing from the scope of the invention as defined by the appended claims.

Reference is made to the NVM Express (NVMe) storage interface for Solid State Drives (SSDs) on a PCIe bus. The latest version of the NVMe specification can be found at www.nvmexpress.org, presently version 1.3 d, dated Mar. 20, 2019, and is incorporated by reference in its entirety herein.

At block 600, block I/O device 300 is operating in a default mode of operation, in this example, one read engine and one write engine enabled, and the remaining data engines disabled. In this configuration, the single read and write engines are capable of processing an moderate number of read and write commands issued by the host computers, for example 40 read and write commands at 10 k IOPS. In one embodiment, no data engines are enabled in a default mode of operation, where processor 400 executes all commands from the hosts, i.e., stores and retrieves data to/from mass storage memory 406.

Further at block 600, processor 400 executes a default arbitration scheme that defines an order in which commands will be processed, or retrieved, by processor 400 or by command handler 520. In the NVMe specification, three arbitration mechanisms are defined, including round robin (where the submission queues of each host computer is checked in a particular order), weighted round robin with urgent priority class (where various submission queues are assigned a high, medium or low priority, and each priority is processed in a round robin style until all of the submission queues in a particular priority have been exhausted, then moving to the next-priority submission queues), and vendor specific arbitration schemes (where vendors may implement a custom priority scheme). In this example, it will be assumed that the arbitration process is a weighted round robin scheme, where initially all submission queues are assigned the same medium priority.

At block 602, in one embodiment, commands are received by processor 400 from the host computers via data bus interface 404 as the host computers issue commands. The commands may be temporarily stored in an input buffer as part of memory 402 and then processed by processor 400 in accordance with the dynamic arbitration scheme.

In another embodiment, utilizing NVMe, submission queue doorbell notifications are received by data bus interface 504 and stored in doorbell register 526. Each doorbell notification indicates which host/submission queue has just stored one or more new commands for processing from a host processor. Doorbell register 526, in turn, notifies command handler 520 that new commands are available, and, in one embodiment, command handler 520 fetches commands from the submission queues in accordance with the dynamic arbitration scheme, as described below. In one embodiment, fetching commands comprises command handler 520 generating a Read AXI Command to data bus interface 504, which in turn generates a PCIe MRD command to the appropriate host computer/submission queue. The requested command(s) are received into an AXI Master Port. Command handler 520 may place into Dword 2 the appropriate SQ_ID, CQ_ID, VF_ID, PF_ID, and port number values onto the retrieved command. Command handler 520 will then increment an appropriate submission queue head pointer value/counter for the particular submission queue that provided the command. In this embodiment, as the commands are received via data bus interface 504, they are routed to a respective FIFO cache buffer 522, where the commands are then processed by a respective data engine.

In another embodiment, command handler 520 fetches commands from the submission queues in order as they are received from doorbell register 526, in accordance with the NVMe specification, and stores them in a buffer memory as part of command handler 520 or memory 502. Then, command handler 520 processes the commands in either the order in which the commands are retrieved, or in accordance with another arbitration scheme for processing the commands. For example, command handler 520 may fetch a number of commands from various hosts/submission queues in an order as determined by the dynamic arbitration scheme, and then command handler 520 may execute the commands in an order determined by another arbitration scheme, such as by giving priority to read commands over write commands, decryption commands over encryption commands, or any other command that may be time-sensitive, i.e., commands where a response from block I/O device 300 is desirable within a very short time frame, such as within 2 seconds.

In any case, the commands may comprise a read command for retrieving data from mass storage 406/506, a write command for writing data from one of the hosts to mass storage 406/506, an encryption command for writing encrypted data to mass storage 406/506 (i.e., using an encryption scheme such as AES, DES, etc.) a decryption command for decrypting data from mass storage 406/506, a compression command for writing compressed data to mass storage 406/506 (i.e., Lempel-Ziv-Welch), a decompression command for decompressing data from mass storage 406/506, an encoding command for encoding data with a particular encoding protocol, such as Viterbi or Reed-Solomon encoding, or a decoding command for decoding data. Other commands include vendor specific commands such as decryption, encryption, and erasure coding. In one embodiment utilizing NVMe, commands are received via data bus interface 504 as a result of command handler 520 determining an order in which to retrieve submission queue commands, in accordance with the dynamic arbitration scheme, then retrieving the submission queue commands from the submission queues in the host computers as prescribed in the NVMe specification.

At block 604, as each command is received by processor 400, processor 400 determines one or more characteristics of the commands and stores them in memory 402. For example, in an NVMe block I/O device 300, characteristics may comprise a source identifier for identifying a host and/or particular submission queue where a command originated (such as a host ID, a submission queue ID (SQ_ID), or a port ID), a completion queue ID (CQ_ID) identifying a completion queue in one of the hosts where a completion queue submission should be stored, a physical function ID (PF_ID) for identifying a physical function of a host, a virtual function ID (VF_ID) for identifying one or more virtual functions and a command operation code value that identifies the type of command, i.e., read, write, encrypt, compress, etc.

At block 606, processor tallies the total number of each characteristic received over a predetermined time period, such as between one and five seconds, with entries older than the predetermined time period erased or removed from memory 402 in a FIFO manner. A rate of each characteristic may also be determined to determine the frequency of each characteristic, i.e., read commands have been received over the past three seconds at a rate of 50 per second, encryption commands received over the past two seconds at a rate of 100 per second, etc. A tally may be kept for characteristics such as the number of commands received from all host computers, the number of commands received from each particular host computer, the number of particular types of commands received from all host computers (i.e., read, write, encrypt, etc.), the number of particular types of commands received from each particular host computer, the number of commands received from specific port IDs, the number of completion queue entries transmitted, the number of, and types of commands received from various physical function IDs, and/or the number of commands received from various virtual function IDs.

At block 608, processor 400 evaluates the number and/or rate of the characteristics in accordance with one or more predictive branching algorithms or neural networks executed by processor 400 or command handler 520 to determine which data engines will most likely be needed to process future commands, based on the tallied characteristics over a predetermined time period. For example, when a host generates a number of successive encrypt commands greater than a threshold, it may be very likely that the same host will issue numerous, further encrypt commands within a short time frame. In another example, when an overall number of commands exceeds a threshold, such as at the beginning of a workday, when large numbers of people begin utilizing network services all at once. In this case, processor 400 may add additional data engines, such as read and write data engines, to accommodate the high number of commands that are likely to continue. In general, the predictive branching algorithm determines whether any of the characteristics have been received at a number, or a rate, that exceeds one or more thresholds for each given characteristic. For example, a predetermined threshold for read commands may be set to 100, or a rate of 100 read commands per second. Similar thresholds may be set for the other characteristics. In some embodiments, the thresholds may be variable, set by processor 400 as processor 400 monitors various operating characteristics of block I/O device 300 over time.

At block 610, processor 400 determines that at least one characteristic has exceeded its predetermined threshold via a predictive branching algorithm.

At block 612, processor 400 modifies operation of block I/O device 300 in response to at least one characteristic exceeding a threshold.

In one embodiment, processor 400 modifies operation of block I/O device 300 by modifying the arbitration scheme to prioritize hosts and/or submission queues that have provided any type of command at a number or rate that has exceeded the threshold. For example, if five host computers has each submitted over 1,500 read and/or write commands in the previous five seconds, processor 400 prioritizes the five host computers by assigning them a “high” priority, processing commands from the five host computers before processing commands from other host computers. In one embodiment, “processed” means executing the commands by processor 400, while in other embodiments, processing means retrieving commands from the hosts. In one embodiment where block I/O device 300 comprises an NVMe storage device, command handler 520 fetches commands from the five hosts in accordance with the NVMe specification first before fetching commands from any other host, unless interrupted by a higher priority host, such as a host that has submitted an administrative command.

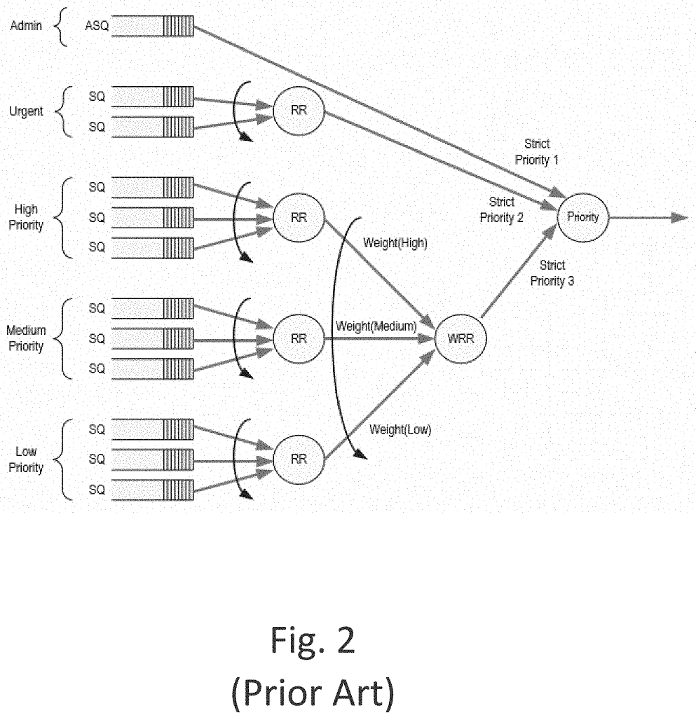

In one embodiment, processor 400 dynamically groups hosts/submission queues in accordance with one of a number of priority levels as the rate of submissions increases or decreases. For example, referencing FIG. 2, five priority levels may be defined, ranging from least urgent to most urgent: “low”, “medium”, “high”, “urgent” and “admin”. In other embodiments, a greater, or fewer, number of priority levels may be defined. Each priority level may be associated with a particular numerical threshold or rate. For example, any host computer/submission queue having fewer than 50 commands per second issued are identified by processor 400 as belonging to the “low” priority group, host computers/submission queues generating between 51 and 100 commands per second are identified by processor 400 as belonging to the “medium” priority group, and so on. Administrative commands may be assigned by processor 400 as having the highest priority. Processor 400 may re-evaluate and re-assign the priority of each of the hosts/submission queues at predetermined time intervals, such as once every five seconds, or upon one or more numeric or rate thresholds are reached, such as at any time that one or more characteristics of any submission queue exceeds a predefined threshold.

In another embodiment, in addition or alternative to modifying the arbitration scheme, as described above, processor 400 may modify operation of block I/O device 300 by enabling or disabling one or more data engines, depending on the number or rate of the characteristics of the commands that have been received over a given time period.

For example, when processor 400 determines that the number or rate of commands of a particular type of command exceeds a predetermined threshold, processor 400 may enable one or more data engines particularly suited to handle the type of command. Similarly, as the number or rate of particular types of commands decrease below either the same threshold or some other, predefined threshold, processor 400 may disable one or more data engines particularly suited to processing those types of commands.

For example, if the total number of encrypt commands received over a given period of time exceeds 2,000, processor 400 may enable encryption engine 516a in response. If the number of encrypt commands exceeds a second threshold of 4,000 encrypt commands per time period, processor 400 may enable encryption engine 516b in response, whereupon both encryption engine 516a and 516b process further encryption commands from FIFO cache buffer 522e, as directed by command handler 520. If the number of encrypt commands exceeds a third threshold of, for example, 5,000 encrypt commands per time period, processor 400 may enable encryption engine 516c in response, whereupon all three encryption engines would process encryption commands from FIFO cache buffer 522e. As the rate of encryption commands falls below 5,000 per time period, processor 400 may disable encryption engine 516c (or one of the other encryption engines) as a result, whereupon encryption engines 516a and 516b remain to process future encryption commands. The same thresholds to determine when to disable a data engine need not be the same threshold used to determine when to enable a data engine.

At block 614, in one embodiment, after each command has been processed by a respective data engine, command completer 524 generates completion queue entries (CQEs) to the host computer that sent the command. Command completer 524 may also generate a MSI/MSI-X message signal interrupt for alerting a host computer that a completion queue entry is available.

It is to be understood that the concepts described herein may also be used in applications other than solid state data storage devices. For example, a host computer coupled to a plurality of storage devices may utilize the concepts described herein to dynamically modify its operation based on data storage device availability, resources, current bandwidth, etc.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

1. A method performed by a block I/O device coupled to a plurality of hosts, comprising:
receiving, by a data bus interface coupled to the processor, host commands from the plurality of hosts coupled to the data bus interface;
storing, by a processor via a memory coupled to the processor, one or more characteristics of each of the host commands; and
modifying, by a processor, operation of the block I/O device based on the one or more characteristics of at least some of the host commands, wherein modifying operation of the block I/O device comprises modifying an arbitration scheme used to retrieve future commands from the hosts.

2. (canceled)

3. The method of claim 1, wherein modifying operation of the block I/O device comprises:
storing host commands in a cache memory;
determining the one or more characteristics of the host commands stored in the cache memory; and
modifying the arbitration scheme used to process the commands stored in the cache memory.

4. The method of claim 1, wherein the one or more characteristics of each of the host commands comprises a rate at which host commands are received from each of the hosts.

5. The method of claim 1, wherein the block I/O device comprises an NVMe solid state drive, and each of the plurality of hosts comprise a submission queue for temporarily storing the host commands generated by each of the plurality of host devices, respectively, wherein modifying operation of the block I/O device based on the one or more characteristics of at least some of the host commands comprises:
receiving doorbell notifications from the hosts when each host command is ready for retrieval by the I/O block device;
identifying, by the processor, a submission queue for each of the host commands received by the processor indicating a source of each of the host commands; and
modifying, by the processor, the arbitration scheme used by the processor to determine an order in which to retrieve future host commands from the plurality of hosts.

6. The method of claim 1, wherein the block I/O device comprises an NVMe solid state drive, wherein modifying operation of the block I/O device based on the one or more characteristics of at least some of the host commands comprises:
identifying, by the processor, a command type of each of the host commands;
determining that a first command type has been received at a rate exceeding a predetermined threshold; and
in response to determining that the first command type has been received at a rate exceeding a predetermined threshold, allocating, by the processor, one or more block I/O device resources to retrieve future host commands matching the first command type.

7. The method of claim 1, wherein the one or more characteristics of each of the host commands comprises a command type.

8. The method of claim 7, wherein the command type is selected from the group consisting of a read command, a write command, and an encrypt command.

9. The method of claim 1, wherein the one or more characteristics of each of the host commands is selected from the group consisting of a port ID, a completion queue ID, a physical function ID and a virtual function ID.

10. The method of claim 1, wherein modifying operation of the block I/O device based on the one or more characteristics of at least some of the host commands comprises allocating, by the processor, one or more block I/O device resources to process future host commands received by the data bus interface.

11. The method of claim 9, wherein modifying the arbitration scheme comprises:
determining a rate at which the host commands have been received from each of the hosts;
assigning a higher priority to a first host that has a higher command receive rate than a command receive rate of a second host.

12. The method of claim 11, wherein allocating one or more block I/O device resources comprises:
determining a rate at which a first host command type is received from each of the hosts; and
allocating a first block I/O device resource to process future commands from the plurality of hosts when the rate exceeds a predetermined threshold.

13. The method of claim 12, wherein the first host command type comprises a read command and the first block I/O device resource comprises a read engine coupled to the processor.

14. A block I/O device for dynamically altering operation of the block I/O device based on host commands received from a plurality of hosts coupled to the block I/O device, comprising:
a data bus interface for receiving host commands from the plurality of hosts;
a memory for storing processor-executable instructions; and
a processor, coupled to the data bus interface and the memory, for executing the processor-executable instructions that causes the block I/O device to:
receive, by the data bus interface, the host commands from the plurality of hosts;
store, by the processor, one or more characteristics of each of the host commands; and
modify, by the processor, operation of the block I/O device based on the one or more characteristics of at least some of the host commands, wherein the processor-executable commands that cause the processor to modify operation of the block I/O device comprises processor-executable commands that cause the processor to modify an arbitration scheme used to retrieve future commands from the hosts.

15. (canceled)

16. The block I/O device of claim 14, wherein the instructions that cause the block I/O device to modify operation of the block I/O device comprises instructions that causes the block I/O device to:
store host commands in a cache memory;
determine the one or more characteristics of the host commands stored in the cache memory; and
modify the arbitration scheme used to process the commands stored in the cache memory.

17. The block I/O device of claim 14, wherein the one or more characteristics of each of the host commands comprises a rate at which host commands are received from each of the hosts.

18. The block I/O device of claim 14, further comprising:
a block I/O resource coupled to the processor;
wherein the block I/O device comprises an NVMe solid state drive, wherein the instructions that cause the block I/O device to modify operation of the block I/O device based on the one or more characteristics of at least some of the host commands further comprises instructions that causes the block I/O device to:
identify, by the processor, a command type of each of the host commands;
determine that a first command type has been received at a rate exceeding a predetermined threshold; and
in response to determining that the first command type has been received at a rate exceeding a predetermined threshold, allocate, by the processor, one or more block I/O device resources to retrieve future host commands matching the first command type.

19. The block I/O device of claim 14, wherein the one or more characteristics of each of the host commands comprises a command type.

20. The block I/O device of claim 19, wherein the command type is selected from the group consisting of a read command, a write command, and an encrypt command.

21. The block I/O device of claim 14, wherein the one or more characteristics of each of the host commands is selected from the group consisting of a port ID, a completion queue ID, a physical function ID and a virtual function ID.

22. The block I/O device of claim 14, further comprising:
a block I/O device resource coupled to the processor for providing additional processing capability to the processor;
wherein the instructions that cause the block I/O device to modify operation of the block I/O device based on the one or more characteristics of at least some of the host commands further comprises instructions that causes the block I/O device to:
determine, by the processor, that the rate of host commands received exceeds a predetermined threshold; and
in response to determining that the rate of host commands received exceeds a predetermined threshold, allocate, by the processor, the block I/O device resource to retrieve future host commands received by the block I/O device.

23. The block I/O device of claim 15, wherein the instructions that cause the block I/O device to modify the arbitration scheme comprise instructions that causes the block I/O device to:
determine, by the processor, a rate at which host commands are received from each of the hosts;
assign, by the processor, a higher processing priority to a first host that has a higher command receive rate than a command receive rate of a second host.

24. The block I/O device of claim 14, further comprising:
a block I/O device resource coupled to the processor for providing additional processing capability to the processor;
wherein the instructions that cause the block I/O device to allocate one or more block I/O resources comprise instructions that causes the block I/O device to:
determine a rate at which a first host command type is received from each of the hosts; and
allocate a first block I/O device resource to process future commands from the plurality of hosts when the rate exceeds a predetermined threshold.

25. The block I/O device of claim 24, wherein the first host command type comprises a read command and the first block I/O device resource comprises a read engine coupled to the processor.
